(19) United States
(12) Patent Application Publication
(10) Pub. No.: US 2024/0251701 A1
(43) Pub. Date: Aug. 1, 2024

(54) AUTONOMOUS WORKING MACHINE AND WORK MANAGEMENT SYSTEM

(71) Applicant: HONDA MOTOR CO., LTD., Tokyo (JP)

(72) Inventors: Kenji NISHIMIYA, Saitama (JP); Nikunj SHAH, Saitama (JP); Rishabh Gopichand RAMTEKE, Saitama (JP)

(21) Appl. No.: 18/161,897

(22) Filed: Jan. 31, 2023

(51) Int. Cl. A01D 34/00; G06V 10/12; G06V 10/46; G06V 20/10; G06V 20/56; H04N 13/207

(52) U.S. Cl. CPC A01D 34/008; G06V 10/12; G06V 10/46; G06V 20/188; G06V 20/56; H04N 13/207; A01D 34/74; A01D 2101/00

(57) ABSTRACT

Problem to be solved: Provided is an autonomous working machine capable of taking appropriate measures for arranging a mowing height in mowing work and improving a finish quality of the mowing work.

Solution: The autonomous working machine includes: a mower body that mows vegetation while traveling; a controller that controls the mower body based on a recorded work operation content; and a rear imager that is directed rearward in an advancing direction of the mower body, in which the controller is configured to, based on an image of a vegetation group including a plurality of pieces of the vegetation acquired by the rear imager, evaluate a shape of the vegetation group.

### BACKGROUND OF THE INVENTION

### Field of the Invention

The present invention relates to an autonomous working machine and a work management system.

### Related Art

In the related art, there is known a technique of measuring a growth condition of grass from information such as a height and a color of grass in a predetermined region and taking appropriate measures such as watering and fertilization based on measurement results (for example, see Japanese Unexamined Patent Application, Publication No. 2021-153482). According to such a technique, it is possible to more appropriately perform tasks such as watering and fertilization on a region where the growth of grass is not good.
Patent Document 1: Japanese Unexamined Patent Application, Publication No. 2021-153482

### SUMMARY OF THE INVENTION

However, the technique in the related art does not discloses how to take more appropriate measures for arranging a mowing height in grass mowing work.

An object of the present invention is to provide an autonomous working machine and a work management system capable of taking appropriate measures for arranging a mowing height in mowing work and improving the finish quality of the mowing work.

(1) The present invention provides an autonomous working machine (for example, a mower 1, 1A to be described below) including: a mower body (for example, a mower body 2 to be described below) that mows vegetation (for example, vegetation Ga to be described below) while traveling; a controller (for example, a controller 5 to be described below) that controls the mower body based on a recorded work operation content; and a rear imager (for example, a rear camera 4 to be described below) that is directed rearward in an advancing direction of the mower body, in which the controller is configured to, based on an image of a vegetation group (for example, a vegetation group including a plurality of pieces of grass Gb to be described below) including a plurality of pieces of the vegetation acquired by the rear imager, evaluate a shape of the vegetation group.

(2) In the autonomous working machine according to (1) above, the rear imager acquires a three-dimensional image of the vegetation group, and the controller evaluates the shape of the vegetation group based on a shape of a contour line (for example, a contour line 501 to be described below) connecting tips (for example, tips P to be described below) of a plurality of pieces of the vegetation in the three-dimensional image of the vegetation group.

(3) In the autonomous working machine according to (2) above, the controller determines the work operation content depending on a result of an evaluation of the shape of the vegetation group based on the shape of the contour line.

(4) In the autonomous working machine according to (3) above, the controller evaluates the shape of the vegetation group based on a degree of change in slope of the contour line or a difference between the contour line and an approximately horizontal line (for example, an approximately horizontal line 503 to be described below) set with respect to the contour line, and determines the work operation content depending on a result of the evaluation.

(5) In the autonomous working machine according to (4) above, the controller evaluates the shape of the vegetation group based on a plurality of thresholds set for the degree of change or the difference, and changes the work operation content depending on a result of the evaluation.

(6) In the autonomous working machine according to any one of (1) to (5) above, the rear imager is configured to acquire at least information on a length or a color of the vegetation in the vegetation group.

(7) The present invention provides a work management system including: a mower (for example, a mower 1B to be described below) that is equipped with a rear imager (for example, a rear camera 4 to be described below) that is directed rearward in an advancing direction to mow vegetation (for example, vegetation Ga to be described below) while traveling; and a controller (for example, a controller 50 to be described below) that is communicable with the mower and controls the mower based on a recorded work operation content, in which the controller is configured to, based on an image of a vegetation group (for example, a vegetation group including a plurality of pieces of grass Gb to be described below) including a plurality of pieces of the vegetation acquired by the rear imager and sent from the mower, evaluate a shape of the vegetation group.

(8) In the work management system according to (7) above, the rear imager acquires a three-dimensional image of the vegetation group, and the controller evaluates the shape of the vegetation group based on a shape of a contour line (for example, a contour line 501 to be described below) connecting tips (for example, tips P to be described below) of a plurality of pieces of the vegetation in the three-dimensional image of the vegetation group.

(9) In the work management system according to (8) above, the controller determines the work operation content depending on a result of an evaluation of the shape of the vegetation group based on the shape of the contour line.

(10) In the work management system according to (9) above, the controller evaluates the shape of the vegetation group based on a degree of change in slope of the contour line or a difference between the contour line and an approximately horizontal line (for example, an approximately horizontal line 503 to be described below) set with respect to the contour line, and determines the work operation content depending on a result of the evaluation.

(11) In the work management system according to (10) above, the controller evaluates the shape of the vegetation group based on a plurality of thresholds set for the degree of change or the difference, and changes the work operation content depending on a result of the evaluation.

(12) In the work management system according to any one of (7) to (11) above, the rear imager is configured to acquire at least information on a length or a color of a plurality of pieces of the vegetation in the vegetation group.

According to the autonomous working machine of (1) above, it is possible to evaluate the presence or absence of unmown grass and non-uniformity of the mowing height from the shape of the vegetation group based on the acquired image of the vegetation group after mowing. Therefore, it is possible to quantitatively grasp the finish quality of the mowing work, and to take appropriate measures for arranging the mowing height in the mowing work depending on the evaluation result. Thereby, the finish quality of the mowing work can be improved.

According to the autonomous working machine of (2) above, since the vegetation can be regarded as a group based on the shape of the contour line, the processing for evaluating the shape of the vegetation group can be performed quickly, and the finish evaluation can be performed close to recognition of vegetation by a person.

According to the autonomous working machine of (3) above, it is possible to determine appropriate work operation contents depending on the finish quality of the vegetation group after mowing.

According to the autonomous working machine of (4) above, since the finish quality of the vegetation group after mowing can be more appropriately evaluated, it is possible to determine more appropriate work operation contents depending on the evaluation result.

According to the autonomous working machine of (5) above, depending on the finish quality of the vegetation group after mowing, the work operation content can be changed to a more appropriate work operation content.

According to the autonomous working machine of (6) above, it is possible to grasp the condition of the vegetation after mowing from the information on the length or the color of the vegetation in the vegetation group captured by the rear imager.

According to the work management system of (7) above, it is possible to evaluate the presence or absence of unmown grass and non-uniformity of the mowing height from the shape of the vegetation group based on the image of the vegetation group after mowing acquired from the mower. Therefore, it is possible to quantitatively grasp the finish quality of the mowing work by the mower, and to take appropriate measures on the mower for arranging the mowing height in the mowing work depending on the evaluation result. Thereby, the finish quality of the mowing work by the mower can be improved.

According to the work management system of (8) above, since the vegetation can be regarded as a group based on the shape of the contour line, the processing for evaluating the shape of the vegetation group can be performed quickly, and the finish evaluation can be performed close to recognition of vegetation by a person.

According to the work management system of (9) above, it is possible to determine appropriate work operation contents depending on the finish quality of the vegetation group after mowing by the mower.

According to the work management system of (10) above, since the finish quality of the vegetation group after mowing by the mower can be more appropriately evaluated, it is possible to determine more appropriate work operation contents depending on the evaluation result.

According to the work management system of (11) above, depending on the finish quality of the vegetation group after mowing by the mower, the work operation content of the mower can be changed to a more appropriate work operation content.

According to the work management system of (12) above, it is possible to grasp the condition of the vegetation after mowing by the mower from the information on the length or the color of the vegetation in the vegetation group acquired from the mower.

### BRIEF DESCRIPTION OF THE DRAWINGS

FIG. 1 is a schematic configuration diagram showing an autonomous working machine;

FIG. 2A is a view showing a state in which grass is appropriately cut;

FIG. 2B is a view showing a condition of the grass cut appropriately;

FIG. 3A is a view showing a state in which grass is inappropriately cut;

FIG. 3B is a view showing a condition of the grass with white whiskers caused by inappropriate cutting;

FIG. 4 is a functional block diagram of the autonomous working machine;

FIG. 5 is a schematic diagram showing an example of a three-dimensional image of a vegetation group acquired by a rear imager of the autonomous working machine;

FIG. 6 is a flowchart showing an example of a control operation of the autonomous working machine;

FIG. 7 is a schematic diagram showing a contour line connecting tips of a plurality of vegetations in a three-dimensional image of a vegetation group;

FIG. 8 is a schematic diagram showing a degree of change of a contour line connecting tips of a plurality of vegetations in a three-dimensional image of a vegetation group;

FIG. 9 is a schematic diagram showing a difference between a contour line connecting tips of a plurality of vegetations in a three-dimensional image of a vegetation group and an approximately horizontal line;

FIG. 10 is a functional block diagram for determining a new work operation content based on an evaluation result of a shape of a vegetation group;

FIG. 11 is a table showing an example of a setting value correction table;

FIG. 12 is a configuration diagram showing a mower according to another embodiment; and

FIG. 13 is a configuration diagram showing an example of a work management system.

### DETAILED DESCRIPTION OF THE INVENTION

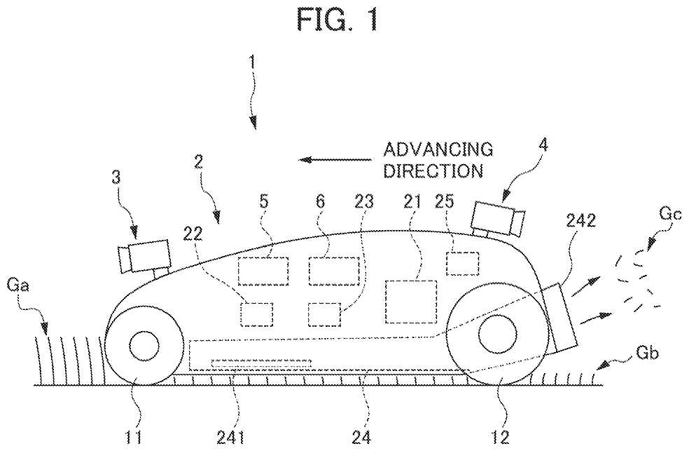

Embodiments of the present invention will be described in detail below with reference to the drawings. FIG. 1 shows a schematic configuration of an autonomous working machine. The autonomous working machine is a working machine that performs various operations for work by its own judgement. The autonomous working machine according to the present embodiment exemplifies a mower 1 that mows grass as vegetation. The grass as vegetation is turfgrass. However, the vegetation to be mowed by the mower 1 may include grass other than the turfgrass.

The mower 1 includes a mower body 2, a front camera 3, a rear camera 4, a controller 5, and a storage unit 6. The mower 1 includes a pair of front wheels 11 and a pair of rear wheels 12 which are provided on left and right sides of the mower body 2, respectively. The mower 1 travels at its own judgement by driving of a drive unit 21 including a motor for traveling built in the mower body 2 or the like to execute mowing work on vegetation within a work area. In addition to the components described above, the mower 1 includes a steering mechanism for changing an advancing direction, a rechargeable battery for driving, and the like, which are not shown in FIG. 1.

A left direction indicated by an arrow in FIG. 1 is an advancing direction at the time of mowing of the mower 1 of the present embodiment. Therefore, in the mower 1 of the present embodiment shown in FIG. 1, a front in the advancing direction is a left direction, and a rear in the advancing direction is a right direction. Further, a width direction of the mower 1 of the present embodiment is a direction perpendicular to the paper plane of FIG. 1.

The mower body 2 includes a blade part for mowing inside a mowing unit 24 arranged at the bottom. A specific structure of the blade part is not particularly limited. The blade part of the present embodiment is configured by a pair of cutter blades 241 arranged side by side in the width direction of the mower body 2. By driving of a motor for blade 22 built in the mower body 2, the cutter blade 241 rotates at a predetermined rotational speed around a rotating shaft arranged substantially perpendicular to the ground, and mows grass Ga in front of the advancing direction. When the mowing work is appropriately performed by the mower 1, grass Gb after the mower 1 has passed is in a state of being adjusted to a predetermined length.

By driving of a motor for lifting 23 built in the mower body 2, the mowing unit 24 is movable in an up-down direction with respect to the mower body 2. As the mowing unit 24 moves in the up-down direction, a height of the cutter blade 241 is adjusted with respect to the ground. A length of the grass Gb after mowing is set by adjustment of the height of the cutter blade 241.

The mowing unit 24 includes a discharge port 242 that opens to the rear of the mower body 2. The discharge port 242 discharges grass clippings Gc cut by the cutter blade 241 while dispersing the grass clippings rearward in the advancing direction by a wind pressure generated by the rotation of the cutter blade 241. The clippings Gc dispersed moderately are reused as soil fertilizer.

The mower 1 includes a speed sensor 25 that detects a traveling speed. The speed sensor 25 is configured by, for example, an encoder that detects a rotational speed of the front wheels 11 or the rear wheels 12.

The front camera 3 is provided on the mower body 2 to be directed forward in the advancing direction. The front camera 3 is a front imager that captures an image of a grass group, which is a vegetation group including a plurality of pieces of grass Ga in front of the advancing direction before mowing, at the time of mowing work. The front camera 3 is attached to a top front of the mower body 2 to be directed downward slightly. However, the front camera 3 is not an essential component.

The front camera 3 captures an image of a condition of the grass Ga in the grass group in front of the advancing direction of the mower 1. A specific example of the front camera 3 may include a camera equipped with a two-dimensional image sensor that recognizes a color image of a grass group including a plurality of pieces of grass Ga. Further, the front camera 3 may be a moisture camera capable of measuring the moisture content of the grass group including the plurality of pieces of grass Ga. An example of the moisture camera may include a near-infrared spectroscopic moisture camera.

The conditions of the grass Ga in the grass group captured by the front camera 3 can include information on the number (a density), a thickness, a color, and the moisture content of the grass Ga. These conditions of the grass Ga can be recognized by image processing of imaging results captured by the front camera 3.

Depending on the number and thickness of the grass Ga in front of the advancing direction, easiness of cutting of the grass Ga can be determined. For example, when the number of pieces of grass Ga is large, or when the thickness of the grass Ga is large, the grass Ga may be difficult to be cut. In such a case, for example, a certain adjustment is required, for example, it is necessary to reduce the traveling speed of the mower 1, or to increase the rotational speed of the cutter blade 241. Therefore, the information on the number of pieces and the thickness of the grass Ga as the information on the condition of the grass Ga can be used as a source for determining the traveling speed of the mower 1 and the rotational speed of the cutter blade 241 for more appropriate mowing work.

The moisture content of the grass Ga is the amount of moisture adhering to the grass Ga. The moisture content of the grass Ga can be measured with the moisture camera. Further, the moisture content of the grass Ga can also be measured by detecting the reflection of light from the grass Ga with a camera having an image sensor. Furthermore, the moisture content of the grass Ga can also include rainfall information or watering information inputted from the outside. The moisture adhering to the grass Ga causes an increase in the mass of the grass Ga. For example, when the moisture content is high, the grass Ga tends to fall down. Therefore, it is difficult to erect the grass Ga, and unmown grass tends to occur. For this reason, the information on the moisture content of the grass Ga can be used as a source for determining an appropriate rotational speed of the cutter blade 241 to generate an updraft that causes the grass Ga, which is fallen down due to the moisture, to erect, for example.

The front camera 3 may include two or more types of cameras, for example, a camera having an image sensor and a near-infrared spectroscopic moisture camera. The front camera 3 captures an image of the grass group including the plurality of pieces of grass Ga in front of the advancing direction before mowing. Front imaging results including the condition of the grass group are sent out to the controller 5.

The rear camera 4 is provided on the mower body 2 to be directed rearward in the advancing direction. The rear camera 4 is a rear imager that captures an image of a grass group including a plurality of pieces of grass Gb behind in the advancing direction after mowing, at the time of mowing work. The rear camera 4 is attached to a top rear of the mower body 2 to be directed downward slightly.

The rear camera 4 can capture a three-dimensional image (3D capture data) of the grass group including the plurality of pieces of grass Gb behind in the advancing direction of the mower 1 after mowing. A specific example of the rear camera 4 may include a stereo camera capable of acquiring 3D capture data. Thus, the rear camera 4 capture a length of the plurality of pieces of grass Gb after mowing. Specifically, the rear camera 4 outputs 3D capture data representing a surface height of the grass group formed by respective tips of the plurality of pieces of grass Gb after mowing.

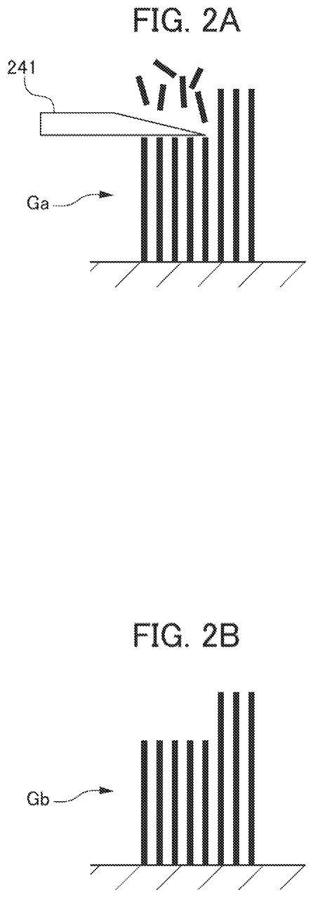

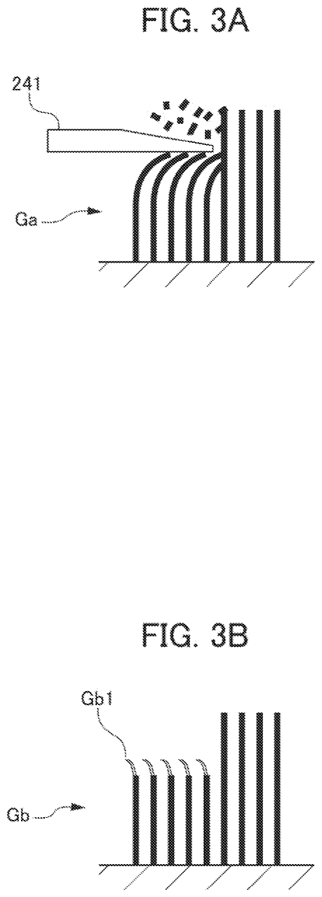

An imaging result captured by the rear camera 4 may include information on a color of the grass Gb after mowing. Depending on the information on the color of the grass Gb after mowing, a finished state of the mowing work is grasped. For example, when the rotational speed of the cutter blade 241 is appropriate, the grass Ga is cleanly cut by the cutter blade 241 as shown in FIG. 2A. Thus, since the grass Gb after mowing is cleanly and uniformly cut to a predetermined length as shown in FIG. 2B, there is no significant difference between the color of the grass Ga before mowing and the color of the grass Gb after mowing. However, when the rotational speed of the cutter blade 241 is slow or when the cutter blade 241 reduces in sharpness due to deterioration, the cutter blade 241 pushes down the grass Ga as shown in FIG. 3A, and the grass Ga is hardly cut cleanly. Consequently, as shown in FIG. 3B, white whiskers Gb1 formed by exposed fibrous substances remain on cut ends of the grass Gb after mowing. Thereby, the color of the grass Gb after mowing becomes whitish as a whole. Therefore, the information on the color of the grass Gb after mowing included in the image captured by the rear camera 4 can be used as a source for determining an appropriate rotational speed of the cutter blade 241, for example.

As described above, the rear camera 4 can include at least information on the length or color of the grass Gb in the grass group including the plurality of pieces of grass Gb after mowing. The imaging results including the 3D capture data of the grass group after mowing are sent out to the controller 5.

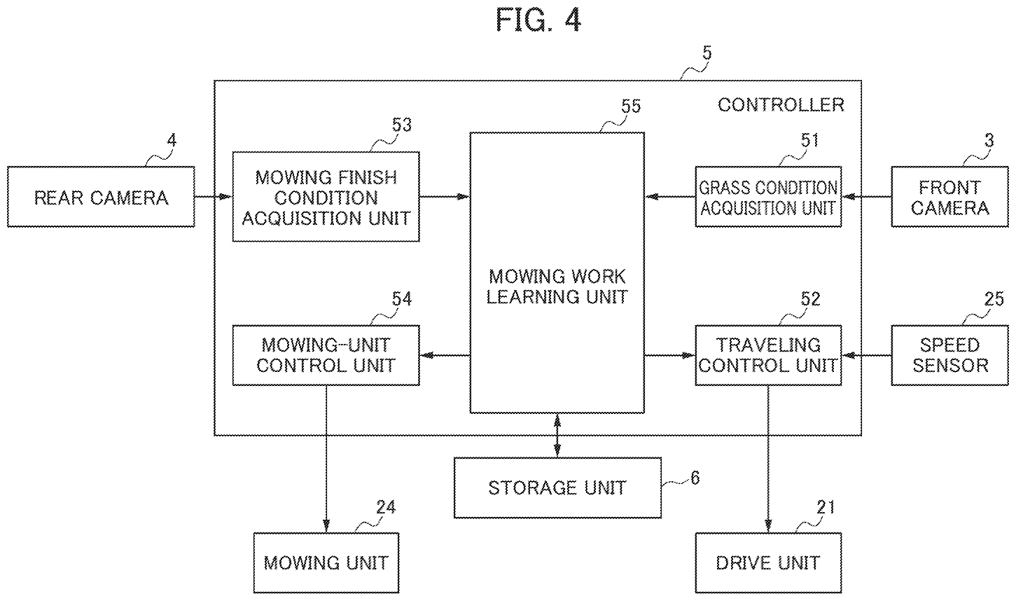

The controller 5 is mounted on the mower body 2 and comprehensively controls an operation for autonomous work of the mower 1. As shown in FIG. 4, the controller 5 includes respective functional blocks of a grass condition acquisition unit 51, a traveling control unit 52, a grass finish condition acquisition unit 53, a mowing-unit control unit 54, and a mowing work learning unit 55.

The controller 5 is configured by an arithmetic processing unit such as a central processing unit (CPU). The controller 5 can includes an auxiliary storage device such as a hard disk drive (HDD) or a solid state drive (SSD) that stores various control programs such as application software and an operating system (OS) for implementing functions of the respective functional blocks, and a main storage device such as a random access memory (RAN) for storing data temporarily required when the arithmetic processing unit executes a program.

The grass condition acquisition unit 51 acquires an image captured by the front camera 3 and showing a condition of a grass group in front of the advancing direction before mowing. The grass condition acquisition unit 51 sends out the acquired image to the mowing work learning unit 55.

The traveling control unit 52 controls the driving of the drive unit 21 for traveling the mower 1, based on a speed command received from the mowing work learning unit 55 and information on the traveling speed of the mower 1 received from the speed sensor 25. Specifically, the driving of the drive unit 21 is driving of the motor for traveling. Under the control of the driving of the motor for traveling, the traveling speed of the mower 1 is adjusted.

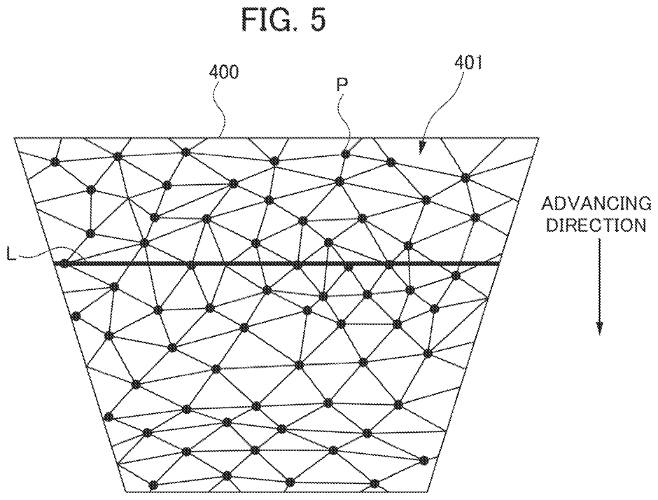

The mowing finish condition acquisition unit 53 acquires an image captured by the rear camera 4 and showing the finish condition of the grass group behind in the advancing direction after mowing. The image captured by the rear camera 4 and showing the finish condition is 3D capture data including information on the length of the plurality of pieces of grass Gb after mowing, that is, information on the mowing height of the grass Gb. The 3D capture data is, as shown in FIG. 5, a three-dimensional surface image 401 of a grass group formed by respective tips P of the plurality of pieces of grass Gb after mowing within an angle of view 400 of the rear camera 4. When the grass Gb after mowing is mowed at an ideal uniform mowing height, the surface image 401 of the grass group after mowing shows a substantially flat surface. On the other hand, when there are variations in the mowing height of the grass Gb after mowing, the surface image 401 of the grass group after mowing shows an uneven surface. FIG. 5 schematically shows an example of a surface image 401 showing an uneven surface when there are variations in the mowing height of the grass Gb after mowing.

The mowing-unit control unit 54 controls the mowing unit 24 based on a mowing height command received from the mowing work learning unit 55. Specifically, the mowing-unit control unit 54 controls the driving of the motor for lifting 23 to adjust the height of the mowing unit 24. Thereby, the height of the cutter blade 241 is adjusted, and the mowing height of the grass Gb is adjusted. The mowing-unit control unit 54 can also adjust the number of rotations of the cutter blade 241 by controlling the driving of the motor for blade 22.

The mowing work learning unit 55 outputs, based on the work operation contents, a control command for mowing work to each of the traveling control unit 52 and the mowing-unit control unit 54. The work operation contents are parameters of the operation of each component of the mower 1 for executing the mowing work, and are stored in the storage unit 6 in advance. The work operation contents include the information on the traveling speed of the mower 1, the information on the rotational speed of the cutter blade 241, and the information on the height (mowing height) of the mowing unit 24.

When the mower 1 is equipped with the front camera 3 as in the present embodiment, the mowing work learning unit 55 receives, from the grass condition acquisition unit 51, the image showing the condition of the grass group in front of the advancing direction before mowing, and determines, based on the image, the condition of the grass Ga before mowing including at least one piece of information such as the number and thickness of grass Ga before mowing and the moisture content of the grass Ga. The mowing work learning unit 55 can perform appropriate arithmetic processing on the work operation contents based on the determination result. The arithmetic processing on the work operation contents based on the determination result of the condition of the grass Ga before mowing can be performed by machine learning, for example. Since the machine learning can use a known method as appropriate, the contents of machine learning will not be described in detail. When the mower 1 is not equipped with the front camera 3, the mowing work learning unit 55 outputs, based on the work operation contents stored in the storage unit 6 in advance, a control command for mowing work to each of the traveling control unit 52 and the mowing-unit control unit 54.

Further, the mowing work learning unit 55 receives, from the mowing finish condition acquisition unit 53, the 3D capture data indicating the condition of the grass group behind in the advancing direction after mowing, and evaluates the degree of mowing finish based on the shape of the grass group after mowing obtained from the 3D capture data. The degree of mowing finish includes information on the presence or absence of uncut portions of the grass Gb after mowing and on the presence or absence of non-uniform mowing height portions of the grass Gb. A specific method will be described below in which the mowing work learning unit 55 evaluates the degree of mowing finish. The mowing work learning unit 55 can determine a new work operation content depending on the evaluation result of the degree of mowing finish. The mowing work learning unit 55 stores the determined new work operation content in the storage unit 6.

The storage unit 6 is mounted on the mower body 2, and is configured by, a semiconductor storage device such as a RAM (random access memory), a magnetic storage device, a flash read only memory (ROM), or other types of nonvolatile storage devices. The storage unit 6 stores at least the work operation content of the mower 1. The work operation content is rewritable, and is modified based on the information sent out from the mowing work learning unit 55.

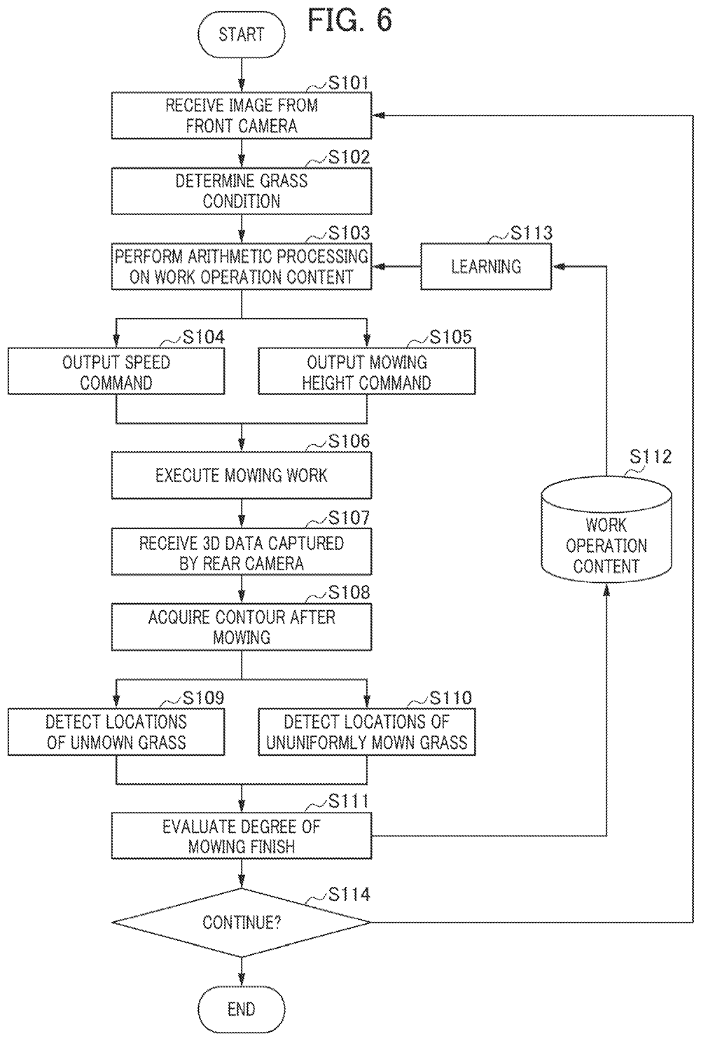

Next, a specific example of the mowing work operation of the mower 1 will be described based on a flowchart shown in FIG. 6.

After the mower 1 starts to operate, the controller 5 receives an image showing the condition of the grass Ga in front of the advancing direction before mowing from the front camera 3 (step S101), and determines, based on the received image, the conditions of the grass Ga, for example, the number and thickness of the grass Ga and the moisture content of the grass Ga in the mowing work learning unit 55 (step S102). The controller 5 performs arithmetic processing on appropriate work operation contents for mowing the grass from the determined condition of the glass Ga before mowing in the mowing work learning unit 55 (step S103). The work operation contents stored in the storage unit 6 is changed to new work operation contents obtained by the arithmetic processing. The arithmetic processing on such work operation contents is performed by machine learning, for example.

The controller 5 outputs a speed command from the traveling control unit 52 to the drive unit 21 based on the work operation contents obtained by the arithmetic processing (step S104). Further, the controller 5 outputs a mowing height command from the mowing-unit control unit 54 to the mowing unit 24 based on the work operation contents obtained by the arithmetic processing (step S105). Thereby, the controller 5 causes the mower 1 to execute mowing work (step S106).

When the mowing work is executed, the controller 5 receives, through the grass condition acquisition unit 51, 3D data of the grass group including the grass Gb after mowing captured by the rear camera 4, that is, the surface image 401 shown in FIG. 5 (step S107). The surface image 401 is continuously acquired during execution of the mowing work.

After acquiring the surface image 401, the controller 5 acquires a contour of the grass group including the plurality of pieces of grass Gb after mowing at a predetermined sampling frequency (step S108).

Processing of acquiring the contour of the grass group will be described. First, the contour of the grass group is a shape indicated by contour lines 501 connecting tips P of the plurality of pieces of grass Gb after mowing as shown in FIG. 7. The contour lines 501 connecting the tips P of the plurality of pieces of grass Gb are obtained from a longitudinal cross-sectional image of the surface image 401 of the grass group shown in FIG. 5.

Specifically, the controller 5 causes the mowing work learning unit 55 to cut the surface image 401 along a line L in the width direction by performing image processing on the surface image 401 shown in FIG. 5 at a predetermined sampling frequency. Thereby, a longitudinal cross-sectional image 500 shown in FIG. 7 is generated. The longitudinal cross-sectional image 500 corresponds an image in which a plurality of pieces of grass Gb are arranged in the width direction of the mower 1. The controller 5 recognizes the tip P of each of the pieces of grass Gb and forms the contour line 501 connecting the adjacent tips P by causing the mowing work learning unit 55 to perform the image processing on the longitudinal cross-sectional image 500. As shown in FIG. 7, the formed contour line 501 indicates the change in the mowing height of the grass Gb after mowing in the width direction of the mower 1.

Next, the controller 5 causes the mowing work learning unit 55 to evaluate the shape of the formed contour line 501, thereby detecting locations of unmown grass (step S109) and further detecting locations of ununiformly mown grass (step S110). The locations of unmown grass and the locations of ununiformly mown grass are determined from the shape of the contour line 501. When the mowing work is performed at a uniform mowing height without unmown grass, the contour line 501 is represented substantially by a linear shape in a horizontal direction. However, when there are the locations of unmown grass or the locations of ununiformly mown grass, the contour line 501 shows an uneven shape due to a local change.

The controller 5 causes the mowing work learning unit 55 to determine the shape of the contour line 501, thereby detecting the locations of unmown grass and the locations of ununiformly mown grass and evaluating the degree of mowing finish with respect to the detected locations of unmown grass and ununiformly mown grass (step S111). The evaluation of the degree of mowing finish is to evaluate the shape of the grass group including the grass Gb after mowing based on the contour line 501.

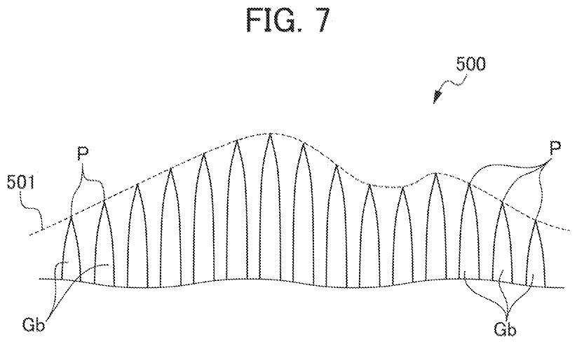

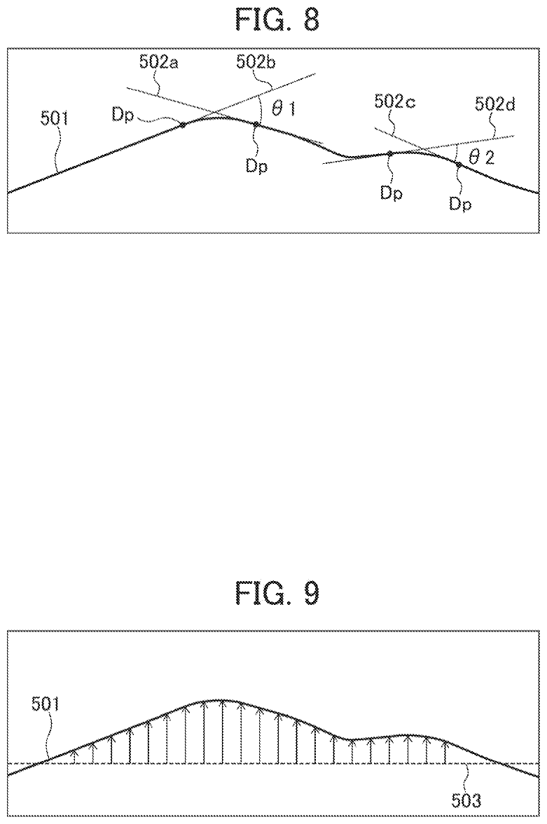

As the degree of change in a slope of the contour line 501 is detected, the shape of the grass group after mowing can be evaluated. When there are the locations of unmown grass or the locations of ununiformly mown grass, the contour line 501 has local unevenness as shown in FIG. 8. The controller 5 causes the mowing work learning unit 55 to form tangential lines 502a, 502b, 502c, 502d . . . of a plurality of arbitrary detection points Dp on the contour line 501, thereby calculating an intersection angle θ1 between the tangential lines 502a and 502b and an intersection angle θ2 between the tangential lines 502c and 502d of the detection points Dp adjacent to each other. When the intersection angles θ1 and θ2 are larger than a predetermined angle, it can be determined that there are the locations of unmown grass or the locations of ununiformly mown grass, and the magnitude of variations in mowing height can be evaluated from sizes of the intersection angles θ1 and θ2.

Further, the shape of the grass group after mowing can also be evaluated by detection of a difference between approximately horizontal lines and the contour line 501. The controller 5 causes the mowing work learning unit 55 to virtually form an approximately horizontal line 503 arranged at an arbitrary height with respect to the contour line 501 as shown in FIG. 9. The approximately horizontal line 503 is arranged at a height corresponding to an ideal mowing height of the grass Gb after mowing, with respect to the contour line 501, for example. The approximately horizontal line 503 may be formed by a straight line substantially horizontal to the ground, and may not necessarily be a straight line completely horizontal to the ground. When the contour line 501 protrudes above the approximately horizontal line 503, the protruding portion is determined to be a portion having a large and ununiform mowing height. The controller 5 causes the mowing work learning unit 55 to calculate, as a difference between the contour line 501 and the approximately horizontal line 503, a change in height of the portion where the contour line 501 protrudes above the approximately horizontal line 504, thereby evaluating the shape of the grass group after mowing.

Note that the controller 5 may also cause the mowing work learning unit 55 to calculate, as a difference between the contour line 501 and the approximately horizontal line 503, an area of the portion where the contour line 501 protrudes above the approximately horizontal line 504, thereby evaluating the shape of the grass group after mowing. Further, even when the contour line 501 is formed to be recessed below the approximately horizontal line 503, the controller 5 may calculate a difference between the contour line 501 and the approximately horizontal line 503 in the same manner as described above, thereby evaluating the shape of the grass group after mowing about the recessed portion.

The shape of the grass group after mowing can be evaluated based on a plurality of thresholds set for the degree of change in the slope of the contour line 501 or the difference between the contour line 501 and the approximately horizontal line 503. For example, a plurality of thresholds are set in the mowing work learning unit 55, the plurality of thresholds being classified into a plurality of stages of, for example, “normal”, “slightly bad”, and “bad” with respect to the degree of change in the slope of the contour line 501 or the calculated difference value between the contour line 501 and the approximately horizontal line 503.

After evaluating the shape of the grass group after mowing, the controller 5 causes the mowing work learning unit 55 to determine a new work operation content based on the evaluation result. Specifically, the controller 5 refers to the current work operation content stored in the storage unit 6 (step S112), and uses machine learning to determine, based on the evaluation result of the shape of the grass group after mowing, a new work operation content necessary for uniformly arranging the mowing height with respect to the current work operation content set in step S103 (step S113).

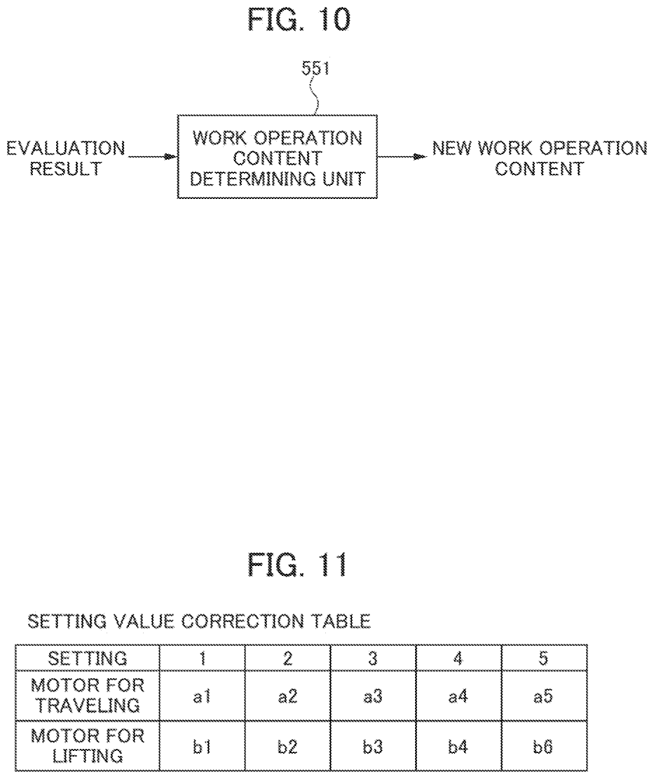

The mowing work learning unit 55 includes a function of a work operation content determining unit 551 as shown in FIG. 10. When the evaluation result is, for example, “slightly bad” or “bad”, the controller 5 causes the work operation content determining unit 551 to determine, based on the evaluation result, a new work operation content necessary for uniformly arranging the mowing height. Specifically, the controller 5 causes the work operation content determining unit 551 to determine, depending on the evaluation result, a height condition of the mowing unit 24 for adjusting the height of the cutter blade 241 to be higher or lower. Further, the controller 5 may cause the work operation content determining unit 551 to determine, depending on the evaluation result, a driving condition of the drive unit 21 for adjusting the traveling speed of the mower 1 to be faster or slower.

The work operation content determining unit 551 can determine a new work operation content with reinforcement learning. The reinforcement learning is to learn the mowing work (a behavior) executed by the mower 1, thereby learning to maximize future rewards. More specifically, the work operation content determining unit 551 selects a behavior for the current work operation content such that the shape of the grass group after mowing thereby is a more excellent shape.

In the reinforcement learning, the work operation content determining unit 551 sets, depending on the result of the mowing work executed based on the current work operation content, for example, a value of the reward to a positive value when the shape of the grass group after mowing is excellent and a value of the reward to a negative value when the shape of the grass group after mowing is bad. The work operation content determining unit 551 performs, for example, deep learning based on the evaluation result of the shape of the grass group after mowing and the value of the reward calculated depending on the evaluation result, and thus determines the work operation content as a new behavior for the current work operation content. The evaluation result of the shape of the grass group after mowing, the work operation content at that time, and the reward are associated with each other by the work operation content determining unit 551, and are accumulated as experience for determining a new work operation content.

The new work operation content determined as a result of the reinforcement learning by the work operation content determining unit 551 includes a content in which more positive rewards can be obtained with respect to the current work operation content set in step S103, for example, the height of the mowing unit 24 is raised or lowered, the traveling speed of the mower 1 is faster or slower, or the like. Specifically, a setting value correction table, for example, shown in FIG. 11 is set in advance in the work operation content determining unit 551. When the current work operation content of the motor for lifting 23 is a setting value of “3”, the work operation content determining unit 551 causes the new work operation content to be changed to, for example, “b2” which is a setting value of “2” or “b4” which is a setting value of “4” depending on the evaluation result of the shape of the grass group after mowing. The controller 5 sends the determined new work operation content to the storage unit 6, and updates the current work operation content stored in the storage unit 6. Thereby, the work operation content is changed to a new work operation content that enables to execute more appropriate mowing work to make the mowing height uniform.

After the evaluation of the degree of mowing finish in step S111, the controller 5 determines whether the mowing work for a predetermined region set in advance has been completed, thereby determining whether to continue the mowing work (step S114). As a result of the determination, when the mowing work for the predetermined region has been completed (NO in step S114), the controller 5 causes the drive unit 21 and the mowing unit 24 to stop, and the mowing work ends. On the other hand, as a result of the determination, when the mowing work for the predetermined region has not been completed (YES in step S114), the controller 5 repeats the processing from the step S101.

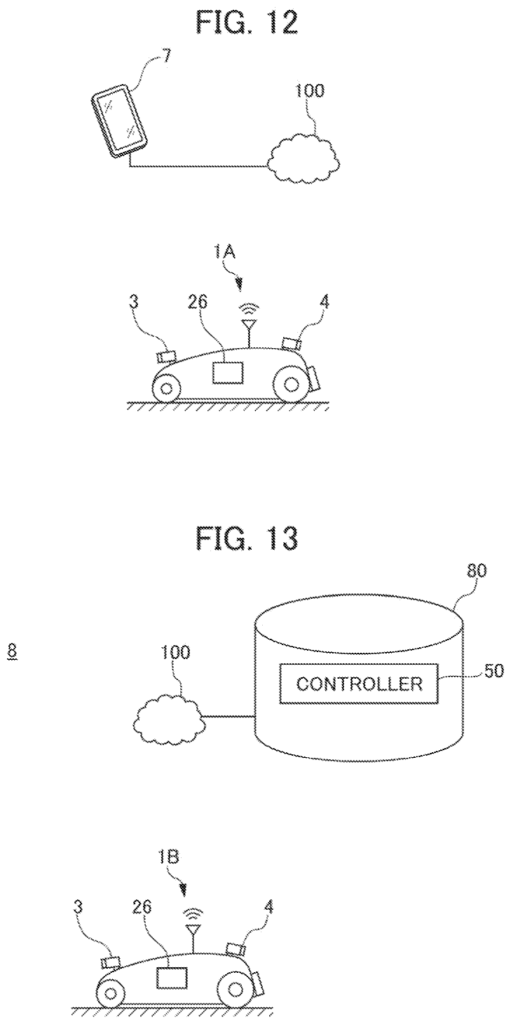

The mower 1 according to the above-described embodiment is configured in which the mower 1 can change the work operation content by the controller 5 built in the mower body 2 and autonomously perform the above-described mowing work. However, a worker may manually change the work operation content depending on the evaluation result obtained after the controller 5 evaluates the shape of the grass group after mowing. FIG. 12 shows an outline of a mower 1A in this case.

The mower 1A shown in FIG. 12 is similar to the mower 1 shown in FIG. 1 except that a communication unit 26 is newly added. The mower 1A is connected to a mobile terminal such as a smart phone, a tablet terminal, or a personal computer owned or managed by the worker by the communication unit 26 so as to be able to communicate data with each other via a communication network 100. The communication network 100 may be a wired communication system such as an optical fiber or a telecommunication line conforming to a standard specification such as Ethernet (registered trademark), or a wireless communication system such as Long Term Evolution (LTE) (registered trademark), a fifth generation wireless communication system, or a wireless LAN system.

In such a case, the mower 1A transmits the evaluation result of the shape of the grass group after mowing to a mobile terminal 7 of the worker via the communication network 100 in the same manner as described above. After confirming the evaluation result with the mobile terminal 7, the worker sets a new work operation content to the mower 1A via the mobile terminal 7 or a user interface such as an operation display (not shown) provided on the mower 1A. The new work operation content may be arbitrarily determined by the determination of the worker depending on the evaluation result, or may be selected from the work operation content, which is determined in advance depending on the evaluation result, by the worker.

According to the mower 1A, a control load of the mower 1A can be reduced. Therefore, the mower 1A can have a simple configuration. Further, since the worker can confirm the state of the mowing work one by one based on the evaluation result of the shape of the grass after mowing sent from the mower 1A, the grass group after mowing can be finished in a shape that makes it less likely for a person to feel uncomfortable.

The mower 1, 1A may not include all or part of the functions of the controller 5 described above. FIG. 13 shows a configuration of a system in this case. The components with the same reference numerals as those of FIGS. 1, 4, and 12 indicate the same components, and thus will not be described below with reference to the description above.

In a work management system 8 shown in FIG. 13, the controller is provided in a management server 80. The controller 50 provided in the management server 80 may include all of the functions of the controller 5 shown in FIG. 4, or may only include some functions including at least the mowing work learning unit 55. The management server 80 is connected to a communication network 100. A mower 1B is provided with a communication unit 26 for performing data communication with the management server 80 via the communication network 100.

In such a work management system 8, based on an image acquired by a rear camera 4 mounted on the mower 1B, the controller 50 of the management server 80 evaluates the shape of the grass group after mowing in the same manner as described above. The management server 80 determines a new operation content based on the evaluation result, and transmits the work operation content to the mower 1B. Thereafter, the mower 1B executes mowing work based on the new work operation content sent from the management server 80. A storage unit 6 of storing the new work operation content may be provided in the mower 1B or may be provided in the management server 80.

According to the work management system 8, a control load of the mower 1B can be reduced. Therefore, the mower 1B can have a simpler configuration.

In each of the above-described embodiments, the mower 1, 1A, 1B is configured to be self-propelled by the drive unit 21, but the mower may not include the drive unit 21. In such a case, the mower may be configured to execute the mowing work while traveling by being pushed manually by the worker, or may be configured to execute the mowing work while traveling by being towed by another self-propelled vehicle, for example.

### EXPLANATION OF REFERENCE NUMERALS

1, 1A, 1B mower (autonomous working machine)
2 mower body
4 rear camera (rear imager)
5, 50 controller
501 contour line
503 approximately horizontal line
8 work management system
Ga, Gb grass (vegetation)
P tip

What is claimed is:

1. An autonomous working machine comprising:
a mower body that mows vegetation while traveling;
a controller that controls the mower body based on a recorded work operation content; and
a rear imager that is directed rearward in an advancing direction of the mower body,
wherein the controller is configured to, based on an image of a vegetation group including a plurality of pieces of the vegetation acquired by the rear imager, evaluate a shape of the vegetation group.

2. The autonomous working machine according to claim 1, wherein
the rear imager acquires a three-dimensional image of the vegetation group, and
the controller evaluates the shape of the vegetation group based on a shape of a contour line connecting tips of a plurality of pieces of the vegetation in the three-dimensional image of the vegetation group.

3. The autonomous working machine according to claim 2, wherein the controller determines the work operation content depending on a result of an evaluation of the shape of the vegetation group based on the shape of the contour line.

4. The autonomous working machine according to claim 3, wherein the controller evaluates the shape of the vegetation group based on a degree of change in slope of the contour line or a difference between the contour line and an approximately horizontal line set with respect to the contour line, and determines the work operation content depending on a result of the evaluation.

5. The autonomous working machine according to claim 4, wherein the controller evaluates the shape of the vegetation group based on a plurality of thresholds set for the degree of change or the difference, and changes the work operation content depending on a result of the evaluation.

6. The autonomous working machine according to claim 1, wherein the rear imager is configured to acquire at least information on a length or a color of the vegetation in the vegetation group.

7. A work management system comprising:
a mower that is equipped with a rear imager that is directed rearward in an advancing direction to mow vegetation while traveling; and
a controller that is communicable with the mower and controls the mower based on a recorded work operation content,
wherein the controller is configured to, based on an image of a vegetation group including a plurality of pieces of the vegetation acquired by the rear imager and sent from the mower, evaluate a shape of the vegetation group.

8. The work management system according to claim 7, wherein
the rear imager acquires a three-dimensional image of the vegetation group, and
the controller evaluates the shape of the vegetation group based on a shape of a contour line connecting tips of a plurality of pieces of the vegetation in the three-dimensional image of the vegetation group.

9. The work management system according to claim 8, wherein the controller determines the work operation content depending on a result of an evaluation of the shape of the vegetation group based on the shape of the contour line.

10. The work management system according to claim 9, wherein the controller evaluates the shape of the vegetation group based on a degree of change in slope of the contour line or a difference between the contour line and an approximately horizontal line set with respect to the contour line, and determines the work operation content depending on a result of the evaluation.

11. The work management system according to claim 10, wherein the controller evaluates the shape of the vegetation group based on a plurality of thresholds set for the degree of change or the difference, and changes the work operation content depending on a result of the evaluation.

12. The work management system according to claim 7, wherein the rear imager is configured to acquire at least information on a length or a color of the vegetation in the vegetation group.
